(19) United States
(12) Patent Application Publication
(10) Pub. No.: US 2025/0168149 A1
(43) Pub. Date: May 22, 2025

(54) METHOD FOR DATA SHARING BETWEEN VIRTUAL ASSET SERVICE PROVIDERS ACROSS A SECURE COMMUNICATION CHANNEL

(71) Applicant: Notabene, Inc., Brooklyn, NY (US)

(72) Inventors: Pelle Steffen Braendgaard, Zürich (CH); Andres Junge, Peñalolén (CL); Richard Crosby, Berlin (DE)

(21) Appl. No.: 18/949,320

(22) Filed: Nov. 15, 2024

Related U.S. Application Data
(60) Provisional application No. 63/599,971, filed on Nov. 16, 2023.

(51) Int. Cl. H04L 9/40

(52) U.S. Cl. CPC H04L 63/04

(57) ABSTRACT

A method includes, during a first time period: accessing first policies of a first entity; accessing second policies of a second entity; identifying the second entity as a candidate counterparty to the first entity; sharing the second policies with the first entity; sharing the first policies with the second entity; receiving confirmations indicating the first entity and the second entity as trusted counterparties; and generating a communication channel between the first entity and the second entity. The method further includes, during a second time period: receiving, from the first entity, a transaction request; identifying the second entity as associated with the transaction request; transmitting the transaction request to the second entity via the communication channel; receiving, from the second entity, a transaction authorization; and transmitting the transaction authorization to the first entity via the communication channel.

### CROSS-REFERENCE TO RELATED APPLICATIONS

This Application claims the benefit of U.S. Provisional Application No. 63/599,971, filed on 16 Nov. 2023, which is incorporated in its entirety by this reference.

### TECHNICAL FIELD

This invention relates generally to the field of communications security and more specifically to a new and useful method for data sharing between virtual asset service providers across a secure communication channel within the field of communications security.

### BRIEF DESCRIPTION OF THE FIGURES

FIG. 1 is a flowchart representation of a method;

FIGS. 2A, 2B, and 2C are flowchart representations of one variation of the method; and

FIGS. 3A, 3B, 3C, and 3D are flowchart representations of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

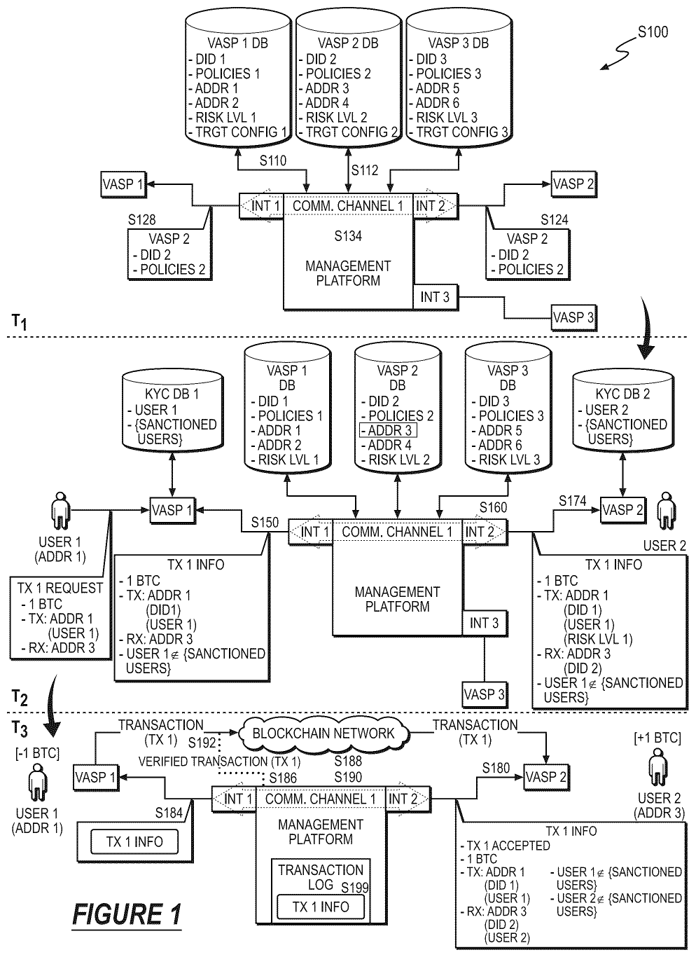

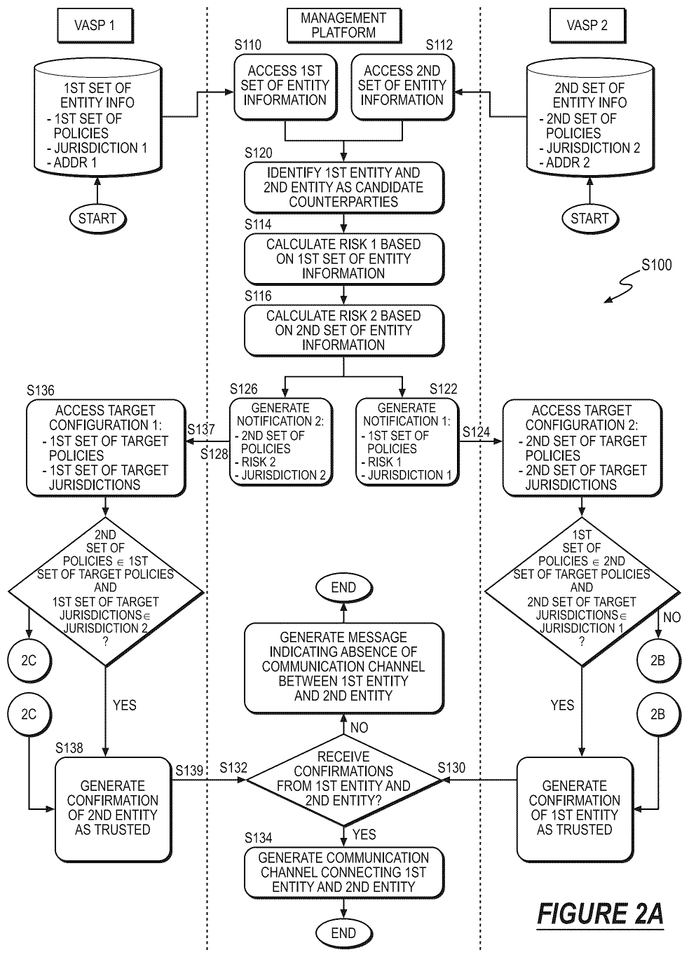

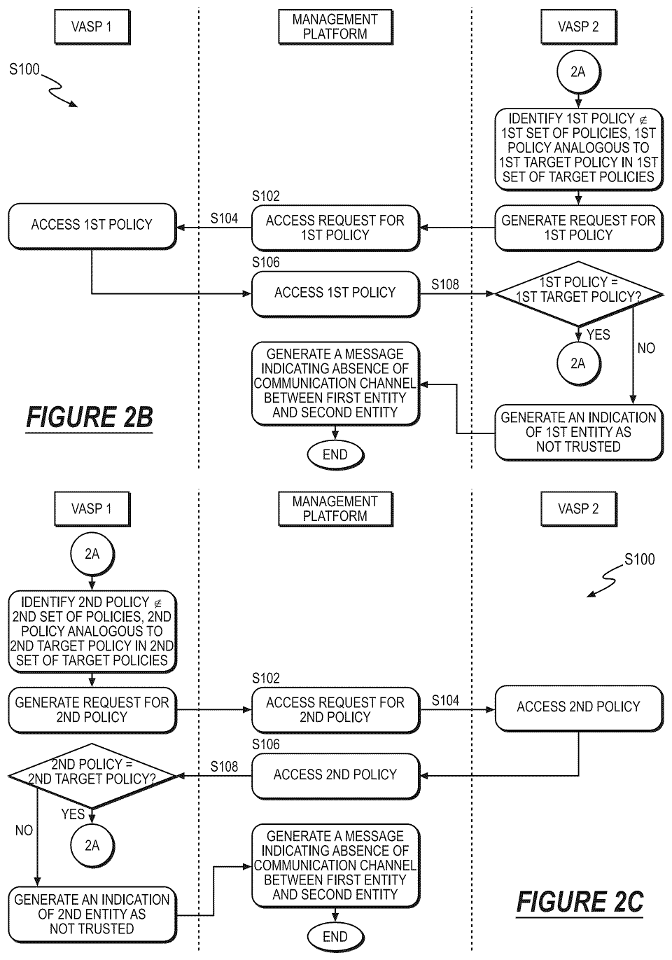

As shown in FIGS. 1, 2A, 2B, 2C, and 3A, a method S100 includes, during a first time period: accessing a first set of policies implemented by a first entity in Block S110; accessing a second set of policies implemented by a second entity in Block S112; identifying the second entity as a candidate counterparty to the first entity based on correspondence between the first set of policies and the second set of policies in Block S120; generating a first notification specifying the first set of policies in Block S122; transmitting the first notification to the second entity in Block S124; generating a second notification specifying the second set of policies in Block S126; transmitting the second notification to the first entity in Block S128; receiving a first confirmation indicating the second entity as trusted by the first entity based on the second set of policies in Block S130; receiving a second confirmation indicating the first entity as trusted by the second entity based on the first set of policies in Block S132; and generating a communication channel between the first entity and the second entity in response to receiving the first confirmation and the second confirmation in Block S136.

The method S100 also includes, during a second time period: receiving a transaction request from the first entity in Block S150, the transaction request representing a transfer of a virtual asset from a first blockchain address associated with a first user identifier to a second blockchain address and confirming absence of the first user identifier from a list of sanctioned user identifiers; identifying the second entity as associated with the transaction request in response to associating the second blockchain address with the second entity during the first time period and the transaction request specifying the second blockchain address in Block S160; transmitting the transaction request to the second entity via the communication channel in Block S174; receiving a transaction authorization from the second entity in Block S180, the transaction authorization indicating acceptance of the transfer of the virtual asset by the second entity based on absence of the first user identifier from the list of sanctioned user identifiers and confirming absence of a second user identifier, associated with the second blockchain address, from the list of sanctioned user identifiers; and transmitting the transaction authorization to the first entity via the communication channel in Block S184.

### 1.1 Variation: Transaction Rejection

As shown in FIGS. 1, 2A, 2B, 2C, 3B, and 3C, one variation of the method S100 includes, during a first time period: accessing a first set of policies implemented by a first entity in Block S110; accessing a second set of policies implemented by a second entity in Block S112; identifying the second entity as a candidate counterparty to the first entity based on correspondence between the first set of policies and the second set of policies in Block S120; generating a first notification specifying the first set of policies in Block S122; transmitting the first notification to the second entity in Block S124; generating a second notification specifying the second set of policies in Block S126; transmitting the second notification to the first entity in Block S128; receiving a first confirmation indicating the second entity as trusted by the first entity based on the second set of policies in Block S130; receiving a second confirmation indicating the first entity as trusted by the second entity based on the first set of policies in Block S132; and generating a communication channel between the first entity and the second entity in response to receiving the first confirmation and the second confirmation in Block S136.

This variation of the method S100 also includes, during a second time period: receiving a transaction request from the first entity in Block S150, the transaction request representing a transfer of a virtual asset from a first blockchain address associated with a first user identifier to a second blockchain address and confirming absence of the first user identifier from a list of sanctioned user identifiers; identifying the second entity as associated with the transaction request in response to associating the second blockchain address with the second entity during the first time period and the transaction request specifying the second blockchain address in Block S160; generating a message representing the transaction request in Block S172; transmitting the message to the second entity via the communication channel in Block S174; receiving a transaction rejection from the second entity in Block S185, the transaction rejection indicating rejection of the transfer of the virtual asset by the second entity based on presence of a second user identifier, associated with the second blockchain address, in the list of sanctioned user identifiers; and transmitting the transaction rejection to the first entity via the communication channel in Block S184.

### 1.2 Variation: Virtual Asset Service Provider

As shown in FIGS. 1, 2A, 2B, 2C, and 3A, one variation of the method S100 includes, during a first time period: receiving a first set of policies implemented by a first virtual asset service provider in Block S110; receiving a second set of policies implemented by a second virtual asset service provider in Block S112; identifying the second virtual asset service provider as a candidate counterparty to the first virtual asset service provider based on correspondence between the first set of policies and the second set of policies in Block S120; granting access of the second set of policies to the first virtual asset service provider in Block S124; granting access of the first set of policies to the second virtual asset service provider in Block S128; receiving a first confirmation indicating the second virtual asset service provider as trusted by the first virtual asset service provider based on the second set of policies in Block S130; receiving a second confirmation indicating the first virtual asset service provider as trusted by the second virtual asset service provider based on the first set of policies in Block S132; and generating a communication channel between the first virtual asset service provider and the second virtual asset service provider in response to receiving the first confirmation and the second confirmation in Block S136.

The method S100 also includes, during a second time period receiving a transaction request from the first virtual asset service provider in Block S150, the transaction request: representing a transfer of a virtual asset from a first blockchain address associated with a first user identifier to a second blockchain address; and confirming absence of the first user identifier from a list of sanctioned user identifiers. The method S100 also includes identifying the second virtual asset service provider as associated with the transaction request in response to: associating the second blockchain address with the second virtual asset service provider during the first time period; and the transaction request specifying the second blockchain address. The method S100 also includes: generating a first message based on the transaction request in Block S172; transmitting the first message to the second virtual asset service provider via the communication channel in Block S174; receiving a transaction authorization from the second virtual asset service provider in Block S180, the transaction authorization indicating acceptance of the transfer of the virtual asset by the second virtual asset service provider based on absence of the first user identifier from the list of sanctioned user identifiers; and confirming absence of a second user identifier, associated with the second blockchain address, from the list of sanctioned user identifiers. The method S100 also includes: generating a second message based on the transaction authorization in Block S182; and transmitting the second message to the first virtual asset service provider via the communication channel in Block S184.

### 1.3 Variation: Transaction Signature

As shown in FIGS. 1, 2A, 2B, 2C, and 3A one variation of the method S100 includes, during a first time period: receiving first entity information associated with a first entity in a set of entities in Block S110, the first entity information specifying a first blockchain address hosted by the first entity; receiving second entity information associated with a second entity in the set of entities in Block S112, the second entity information specifying a second blockchain address hosted by the second entity; identifying the second entity as a candidate counterparty to the first entity in Block S120; identifying the first entity as a candidate counterparty to the second entity in Block S121; generating a second notification specifying the second entity information in Block S126; generating a first notification specifying the first entity information in Block S122; transmitting the second notification to the first entity in Block S128; transmitting the first notification to the second entity in Block S124; and, based on correspondence between the first entity information and the second entity information, establishing a first communication channel between the first entity and the second entity in Block S136.

The method S100 also includes, during a second time period succeeding the first time period: receiving, from the first entity, transaction information representing a transfer of a virtual asset from the first blockchain address to the second blockchain address in Block S150, the transaction information confirming absence of a first user identifier, associated with the first blockchain address, from a set of sanctioned user identifiers; based on the transaction information and the second entity information, identifying the second entity as a beneficiary entity associated with the transfer of the virtual asset in Block S160; generating a first message representing the transaction information in Block S172; and transmitting the first message to the second entity based on the first communication channel in Block S174.

The method S100 further includes receiving a transaction authorization indicating acceptance, by the second entity, of the transfer of the virtual asset and confirming absence of a second user identifier, associated with the second blockchain object, from the set of sanctioned user identifiers in Block 180.

The method S100 also includes: generating a second message indicating acceptance, by the second entity, of the transfer of the virtual asset and confirming absence of the second user identifier from the set of sanctioned user identifiers in Block S182; and transmitting the third message to the first entity based on the first communication channel in Block S184.

The method S100 further includes: receiving a transaction representing the transfer of the virtual asset from the first blockchain address to the second blockchain address in Block S186; in response to absence of the first user identifier and the second user identifier from the set of sanctioned user identifiers, updating the transaction—as a verified transaction—in Block S188 and including a signature verifying the transfer of the virtual asset from the first blockchain address to the second blockchain address in Block S190; and transmitting the verified transaction to a distributed network of nodes for commitment to a block of a blockchain in Block S192.

### 2. Applications

Generally, a computer system—including a management platform—can execute Blocks of the method S100: to establish communication links with a set of entities (e.g., virtual asset service providers); to receive entity information (e.g., “Know Your Customer” policies, “Anti-Money-Laundering” policies, “Travel Rule” policies, data security policies, hosted blockchain addresses) for each entity in the set of entities; to identify a first entity (e.g., a first virtual asset service provider) and a second entity (e.g., a second virtual asset service provider), in the set of entities, that are candidate counterparties to each other in future transactions; and to generate a secure communication channel between the first entity and the second entity.

Accordingly, the computer system can execute Blocks of the method S100: to notify—to the first entity—presence of the second entity; to notify, to the second entity, presence of the first entity; and to pre-share selected entity information (e.g., policies) between the first entity and the second entity via the secure communication channel prior to execution of a transaction request associated with these entities. Therefore, the computer system can execute Blocks of the method S100 to enable the first entity and the second entity: to specify a first set of policies associated with the first entity; to specify a second set of policies associated with the second entity; to identify correspondence between the first set of policies and the second set of policies, such as a sanctions screening policy included in these sets of policies; and to establish trust between these entities based on this correspondence.

### 2.1 Entity Discovery & Transaction Data Sharing

Additionally, the computer system can execute Blocks of the method S100: to receive transaction information—associated with a transfer of a virtual asset (e.g., a cryptocurrency, a token) from a first blockchain address, hosted by first entity, to a second blockchain address—from the first entity; and to identify the second entity as affiliated with the transfer based on the second blockchain address pre-registered within entity information.

Accordingly, the computer system can execute Blocks of the method S100: to resolve blockchain addresses to real-world identities of entities hosting (and/or users transacting with) these blockchain addresses; to generate messages representing transaction information (e.g., blockchain addresses, entity information, user information, sanctions screening results, transfer acceptance); and to transmit these messages across the secure communication channel to the first entity and the second entity. Therefore, the computer system can execute Blocks of the method S100 to enable these entities: to execute due diligence processes based on the transaction information; and to comply with policies for sanctions screening and/or transaction recordkeeping.

### 3. Terminology

Generally, a “virtual asset” is referred to herein as a digital representation of value, excluding digital representation of fiat currencies, such as: a cryptocurrency asset; a token; etc.

Generally, a “virtual asset service provider” is referred to herein as an entity that, on behalf of a user (e.g., a human user, an organization): exchanges between virtual assets and fiat currencies; exchanges between virtual assets; transfers virtual assets; and/or stores (and/or administrates) virtual assets or instruments control over virtual assets; etc.

Generally, a “signature” is referred to herein as a mathematical scheme for verifying authenticity of digital messages and/or data (e.g., acceptance of a transaction, verification of elements associated with a transaction).

### 4. System

Generally, a computer system (hereinafter “the system”) can include and/or interface with: a set of entities representing (or “hosting”) blockchain addresses (e.g., wallets); a management platform; and a population of user devices. The set of entities, the management platform, and/or the population of user devices can be communicatively coupled via a communication network (e.g., the Internet, a wide area network, a local area network).

### 4.1 Entity

In one implementation, an entity (e.g., a computer device) can include a virtual asset service provider (hereinafter “VASP”) (e.g., a cryptocurrency exchange, a financial institution). In this implementation, the VASP represents (or “hosts”) a set of blockchain addresses (e.g., custodial wallets) for a set of users (e.g., human users, organizations), each blockchain address representing a virtual location at which a virtual asset (or an amount of a virtual asset) may be stored, to which a virtual asset may be deposited, and/or from which a virtual asset may be withdrawn. The entity can receive requests—from user devices, in the population of devices, associated with users in the set of users—to execute transactions associated with blockchain addresses associated with these users.

In another implementation, the entity can include a user device associated with a user. In this implementation, the user device represents (or self-hosts) a blockchain address (e.g., a non-custodial wallet) for the user.

### 4.1.1 User Registration

In one implementation, a first entity (e.g., a first VASP), in the set of entities, receives user information (e.g., personally identifiable information, a full name, a physical address, a birthdate)—associated with a first user in a first set of users—from a first user device in the population of devices.

In this implementation, the first entity can verify the user information based on corroborating information (e.g., a government-issued identification document, a utility bill) received from the first device. In response to receiving and verifying the user information, the first entity can: store the user information in a data repository (e.g., a first user database); and assign a first blockchain address (or a first set of blockchain addresses) to the first user.

Accordingly, by validating the user information associated with the first user, the first entity can reduce risk of fraudulent activity associated with the first blockchain address assigned to the first user and hosted by the first entity.

The first entity can repeat the foregoing process for each user in the first set of users.

### 4.1.2 Virtual Asset Transaction

In one implementation, the first entity executes a request—from the first user device associated with the first user—for a transfer of a virtual asset (or an amount of the virtual asset) from the first blockchain address to a second blockchain address, such as a second blockchain address associated with a second user and hosted by a second entity (e.g., a second VASP) in the set of entities. More specifically, the first entity: generates a transaction representing the transfer of the virtual asset from the first blockchain address to the second blockchain address; and transmits—via the communication network—the transaction to a distributed network of nodes for validation and commitment to a block of a blockchain.

### 4.1.3 Due Diligence

In another implementation, the first entity transmits the transaction in response to accessing transaction information associated with the transfer of the virtual asset from the first blockchain address to the second blockchain address.

More specifically, the first entity can access the transaction information including: a virtual asset type; an amount (or value) of the virtual asset to transfer; a first user identifier (e.g., a first full name) of the first user; the first blockchain address; a first entity identifier (e.g., a first decentralized identifier) of the first entity; a second user identifier (e.g., a second full name) of the second user; the second blockchain address; and/or a second entity identifier (e.g., a second decentralized identifier) of the second entity hosting the second blockchain address; etc.

In one example, the first entity accesses transaction information based on the request—for the transfer of the amount of the virtual asset—specifying: the virtual asset type; the amount of the virtual asset to transfer; the first blockchain address; and the second blockchain address. The first entity then, based on the first blockchain address specified in the request: accesses—from the first user database—the first user identifier, of the first user, to which the first blockchain address is assigned; accesses a set of target identifiers (e.g., a list of names of sanctioned users); and, in response to absence of the first user identifier of the first user from the set of target users, transmits the transaction to the distributed network.

Accordingly, the first entity can: receive a request for a transfer of a virtual asset between a group of users; screen the request for a sanctioned user within the group of users (e.g., screen the first user as a possible sanctioned user according to a policy specifying sanctions screening); and execute a transaction representing the transfer in response to absence of a sanctioned user within the group of users, thereby complying with jurisdictional regulations (e.g., anti-money-laundering policies) and reducing risk exposure (e.g., money laundering risk) of the first entity.

### 4.2 Blockchain Structure

Generally, the system can further include the distributed network of nodes (e.g., computer devices) interconnected through a communication medium (e.g., the Internet, a wide area network, a local area network).

In one implementation, the distributed network of nodes (or a subset of nodes in the distributed network of nodes): receives a transaction—from an entity—representing a transfer of an amount of a virtual asset from a first blockchain address to a second blockchain address; validates the transaction; and generates a block representing (or including) the transaction; and appends the block to a blockchain.

### 4.3 Management Platform

Generally, the management platform (e.g., a computer device) can: establish (or generate) communication links with entities in the set of entities; expose each of these entities to other entities in the set of entities; generate communication channels between entities in the set of entities; and manage communication across these communication channels.

In one implementation, the management platform generates a communication channel—between the first entity and the second entity—through which a set of transaction information, associated with a transfer of a virtual asset, may be exchanged.

### 5. Entity Registration

The method S100 includes: accessing a first set of policies implemented by the first entity in Block S110; and accessing a second set of policies implemented by the second entity in Block S112.

Generally, in Blocks S110 and S112, the management platform can: access entity information—of the first entity in a set of entities—such as policies (e.g., know your customer policies, anti-money laundering policies, counter terrorism financing policies) implemented by the first entity, blockchain addresses hosted by the first entity, and a jurisdiction(s) under which the first entity is governed; and access entity information—of the second entity in a set of entities—such as policies implemented by the second entity, blockchain addresses hosted by the first entity, and jurisdiction of the second entity. Therefore, based on correspondence between policies of a pair of entities in the set of entities, the management platform can identify the pair of entities as candidate counterparties.

In one implementation, the management platform receives entity information from an entity, such as via a communication link (e.g., an encrypted communication link) between the management platform and the entity.

For example, the management platform can receive the entity information including: an identifier (e.g., a name, an identification number) associated with the entity; a jurisdiction (e.g., a country) governing the entity; a set of policies associated with the entity (e.g., security policies, data storage policies, regulatory requirements under which the entity operates, transaction recordkeeping policies); etc.

In another implementation, the management platform can: verify the entity information (e.g., based on corroborating information retrieved from an external data repository); and assign a risk level (or a risk score) (e.g., a “high” risk level corresponding to a high-risk entity, a “low” risk level corresponding to a low-risk entity, a “medium” risk level corresponding to a low-risk entity in a high-risk jurisdiction) to the entity based on the entity information. In response to the risk level falling below a risk threshold, the management platform can register (or add) the entity to the set of entities. Alternatively, in response to the risk level exceeding the risk level threshold, the management platform omits the entity from the set of entities.

Accordingly, the management platform can register the set of entities that are trusted by the management platform based on verified entity information and risk levels of entities in the set of entities. Therefore, the management platform can: identify entities—in the set of entities—to each other; establish communication channels between these entities; and manage communication across these communication channels, as described below.

In one implementation, the management platform stores entity information for each entity in the set of entities. More specifically, for each entity in the set of entities, the management platform can: assign a data repository, in a set of data repositories, to the entity; encrypt entity information associated with the entity as encrypted entity information; and store the encrypted entity information in the data repository assigned to the entity.

Additionally, the management platform can store the risk level assigned to the entity.

### 5.1 Blockchain Address Registration

In one implementation, the management platform receives the entity information further including a set of blockchain addresses hosted by an entity in the set of entities. The management platform can: encrypt the set of blockchain addresses—such as based on a cryptographic hash function—as a set of encrypted blockchain addresses; and store the encrypted blockchain addresses in the data repository (e.g., first database of blockchain addresses) assigned to the entity.

In one variation, the entity encrypts the set of blockchain addresses as the encrypted set of blockchain addresses.

In this variation, the management platform: receives the encrypted set of blockchain addresses from the entity; and stores the encrypted set of blockchain addresses in the data repository assigned to the entity.

In another implementation, the management platform can: receive a first blockchain address, in a first set of blockchain addresses, associated with a first entity (e.g., a first VASP); encrypt the first blockchain address into an encrypted first blockchain address; generate a first record representing the encrypted first blockchain address linked to the first entity; and store the first record in a database of blockchain addresses.

The management platform can repeat the foregoing methods and techniques for each entity in the set of entities. For example, the management platform can: receive a second blockchain address, in a second set of blockchain addresses, associated with a second entity (e.g., a second VASP); encrypt the second blockchain address into an encrypted second blockchain address; generate a second record representing the encrypted second blockchain address linked to the second entity; and store the second record in a database of blockchain addresses.

Accordingly, the management platform can store records linking blockchain addresses to entities hosting these blockchain addresses. Therefore, in response to receiving transaction information (e.g., a transaction request) specifying target a blockchain address corresponding to a registered blockchain address represented in a record, the management platform can identify an entity hosting the registered blockchain address as a participant associated with the transaction request based on the record.

In another implementation, the management platform assigns a risk level (or a risk score) (e.g., a “high” risk level corresponding to a high-risk blockchain address, a “low” risk level corresponding to a low-risk blockchain address) to a blockchain address in the set of blockchain addresses. For example, the management platform can assign the risk level based on: a transaction history associated with the blockchain address; an entity hosting the blockchain address; and/or an identifier of a user associated with the blockchain address; etc.

Additionally, the management platform can: receive an identifier (e.g., a full name, an identification number) of a user associated with a blockchain address in the set of blockchain addresses; encrypt the identifier as an encrypted identifier; and store the encrypted identifier in the data repository. The management platform also can assign a risk level (or a risk score) to a user (or user identity), such as based on a transaction history associated with the user (or user identity), a jurisdiction of the user, etc.

### 5.2 Target Counterparty Configuration Generation

In one implementation, the management platform can generate a first target counterparty configuration for the first entity, the first target counterparty configuration representing a first set of target policies and a first set of target jurisdictions characterizing a target entity trusted by the first entity. For example, the management platform can generate—for the first entity—the first target counterparty configuration specifying a target security policy, a target data storage policy, a target regulatory requirement, a target sanctions screening policy, and a target transaction recordkeeping policy implemented by entities trusted by the first entity.

In one example, the management platform can: prompt the first entity to specify the first set of target policies and the first set of target jurisdictions of entities trusted by (or in a counterparty relationship with) the first entity; and generate the first target counterparty configuration based on the first set of target policies and the first set of target jurisdictions specified by the first entity. Accordingly, the management platform can generate the target counterparty configuration—representing a minimum set of policies implemented by entities trusted by the first entity and jurisdictions of entities trusted by the first entity—for the first entity based on information provided by the first entity.

In another example, the management platform can prompt the first entity to: provide responses to a set of prompts (e.g., a questionnaire, does the comply with travel rules, does the entity implement wallet address screening, etc.); access a set of responses to the set of prompts; and compile the set of responses into the first target counterparty configuration. Accordingly, the management platform can generate the first target counterparty configuration—representing a minimum set of policies implemented by entities trusted by the first entity and jurisdictions of entities trusted by the first entity—for the first entity based on responses to the set of prompts (e.g., the questionnaire) specified by the first entity.

The management platform can repeat the foregoing methods and techniques to generate a second target counterparty configuration for the second entity, the second target counterparty configuration representing a second set of target policies and a second set of jurisdictions (e.g., the second set of target policies and the second set of jurisdictions trusted by the second entity).

Accordingly, the management platform can cooperate with an entity to generate—for the entity—the target counterparty configuration specifying policies and jurisdictions implemented by entities trusted by the entity.

Therefore, based on the target counterparty configuration, the management platform can identify candidate counterparties that may be trusted by the entity. In addition, based on the target counterparty configuration, the management platform can automatically verify that the candidate counterparties meet minimum regulatory requirements of the entity, thereby enabling the entity to establish trust with the candidate counterparty sooner. Additionally or alternatively, the management platform can transmit the target counterparty configuration to the entity, thereby enabling the entity to identify other entities as trusted based on the first target counterparty configuration.

### 6. Candidate Counterparty Identification

Block S120 of the method S100 recites identifying the second entity as a candidate counterparty to the first entity based on correspondence between the first set of policies and the second set of policies.

In Block S120, the management platform can: detect correspondence (e.g., match, similarity) between the first set of policies and the second set of policies; and, based on the correspondence, identify the second entity as a candidate counterparty to the first entity and identify the first entity as a candidate counterparty to the second entity. Therefore, based on correspondence between two sets of policies, the management platform can identify a pair of entities, in the set of entities, that may enter into a trusted counterparty relationship and cooperate (with each other and with the management platform) to complete virtual asset transactions while meeting their regulatory requirements.

In one implementation, the management platform can: access the first set of policies implemented by the first entity and including a first sanctions screening policy associated with the list of sanctioned user identifiers; and access the second set of policies implemented by the second entity and including a second sanctions screening policy associated with the list of sanctioned user identifiers. Then, the management platform can: detect correspondence between the first set of policies and the second set of policies in response to the first sanctions screening policy matching the second sanctions screening policy; and identify the second entity as a candidate counterparty to the first entity based on correspondence between the first set of policies and the second set of policies.

Accordingly, the management platform can detect correspondence between the first set of policies and the second set of policies in response to the first sanctions screening policy and the second sanctions screening policy specifying the same list of sanctioned users. Thus, the management platform can identify the second entity as a candidate counterparty to the first entity in response to both entities implementing one or more of the same policies.

Additionally, or alternatively, the management platform can identify the second entity as a candidate counterparty to the first entity in response to: both entities specifying the same jurisdiction; and/or frequency of transaction requests between blockchain addresses hosted by both entities exceeding a threshold frequency.

Therefore, based on the first set of policies, the second set of policies, and other entity information accessed by the management platform from the first entity and the second entity, the management platform can identify the first entity and the second entity as candidate counterparties that may cooperate (with each other and with the management platform) to complete virtual asset transactions while meeting their regulatory requirements.

### 6.1 Counterparty Identification via Target Counterparty Configuration

In one implementation, the management platform can: identify the second entity as a candidate counterparty to the first entity; detect presence of the first set of target policies—specified in the first target counterparty configuration—of the first entity in the second set of policies of the second entity; and detect presence of the second jurisdiction of the second entity in the first set of target jurisdictions—specified in the first target counterparty configuration—of the first entity.

Accordingly, the management platform can detect that the second entity fulfills conditions (e.g., a minimum set of conditions)—specified in the first target counterparty configuration—for identification as “trusted” by the first entity.

Then, in response to detecting presence of the first set of target policies in the second set of policies and detecting presence of the second jurisdiction in the first set of target jurisdictions, the management platform can generate the first notification: specifying the second set of policies; and indicating compliance of the second set of policies and the second jurisdiction with the first target counterparty configuration of the first entity. The management platform can then transmit the first notification to the first entity.

Accordingly, in response to detecting that the second entity fulfills the minimum set of conditions—specified in the first target counterparty configuration—for identification as “trusted” by the first entity, the management platform can share the second set of policies of the second entity with the first entity.

For example, the management platform can: detect that the second set of policies includes the set of target policies implemented by entities trusted by the first entity; detect that the set of target jurisdictions of entities trusted by the first entity include the second jurisdiction of the second entity; and transmit the first notification—specifying, at least, that the second set of policies includes the second set of target policies and that the set of target jurisdictions includes the second jurisdiction of the second entity—to the first entity.

The management platform can repeat the foregoing methods and techniques to: detect presence of the second set of target policies—represented in the second target counterparty configuration—of the second entity in the first set of policies of the second entity; detect presence of the first jurisdiction of the second entity in the second set of target jurisdictions—represented in the second target counterparty configuration—of the second entity; generate the second notification specifying the first set of policies and indicating compliance of the first set of policies and the first jurisdiction with the second target counterparty configuration of the second entity; and transmit the second notification to the second entity.

Accordingly, the management platform can: verify presence of a second set of policies and/or a second jurisdiction of a second entity in a target counterparty configuration of a first entity; and indicate—to the first entity—the presence of the second set of policies and the second jurisdiction in the target counterparty configuration. Therefore, the management platform can automatically initiate (and/or execute) a portion of the due diligence process executed by the first entity to establish trust with the second entity. Thus, the management platform can enable the first entity to withhold verifying that the second set of policies and the second jurisdiction meet conditions (e.g., the minimum set of conditions, regulatory requirements, sanctions screening requirements) set by the first entity and represented in the first target counterparty configuration, thereby enabling the first entity to establish trust with the second entity.

### 7. Entity Information Sharing

The method S100 includes: generating a first notification specifying the first set of policies in Block S122; transmitting the first notification to the second entity in Block S124; generating a second notification specifying the second set of policies in Block S126; and transmitting the second notification to the first entity in Block S128.

In one variation, the method S100 includes: granting the first entity access to the second set of policies in Block S124; and granting the second entity access to the first set of policies in Block S128.

Generally, in Blocks S122, S124, S126, and S128, the management platform can grant an entity access to a set of policies of a candidate counterparty of the entity.

Therefore, the management platform can pre-share the set of policies of the candidate counterparty of the entity with the entity prior to initiation of a transaction between the entity and the candidate counterparty, thereby enabling the entity to review the set of policies of the candidate counterparty, and identify the candidate counterparty as “trusted” if the set of policies of the candidate counterparty fulfil the regulatory requirements of the entity, or “not trusted” if the set of policies does not fulfil the regulatory requirements of the entity. Thus, the management platform can enable due diligence between entities prior to transactions between these entities in order to reduce transaction latency and increase transaction throughput.

In one implementation, the management platform: identifies the second entity as a candidate counterparty to the first entity; accesses second entity information associated with the second entity; generates a second notification identifying the second entity as the candidate counterparty to the first entity and specifying the second entity information; and transmits the second notification to the first entity.

For example, the management platform can generate the second notification specifying the second entity information including: a second entity identifier associated with the second entity; a second jurisdiction governing the second entity; a second set of policies associated with the second entity; etc.

The management platform can also: identify the first entity as a candidate counterparty to the second entity; and access first entity information associated with the first entity. The management platform can generate a first notification: identifying the first entity as the candidate counterparty to the second entity; specifying the first entity information (e.g., a first entity identifier associated with the first entity, a first jurisdiction governing the first entity, a first set of policies associated with the first entity); and including a first request to connect the first entity and the second entity via a first communication channel between the first entity and the second entity. Then, the management platform can transmit the first notification to the second entity.

Accordingly, the management platform can: notify presence of the first entity and the second entity to each other; and share verified entity information—such as the first set of policies, associated with the first entity, and the second set of policies associated with the second entity—between these entities. Therefore, the management platform enables the first entity and the second entity: to identify correspondence between the first set of policies and the second set of policies, such as a first policy specifying sanctions screening and/or a second policy specifying encrypted data storage; and to establish trust between these entities based on this correspondence.

In another implementation, the management platform can: access a first set of policies of a first entity; access a second set of policies of a second entity; calculate a first risk level for the first entity based on the first set of policies in Block S114; calculate a second risk level for the second entity based on the second set of policies in Block S116; generate the first notification specifying the first set of policies and the first risk level of the first entity; transmit the first notification to the second entity; generate the second notification specifying the second set of policies and the second risk level of the second entity; and transmit the second notification to the first entity. For example, based on anti-money laundering and counter terrorism financing policies of the first entity, the management platform can calculate the first risk level (e.g., risk score) of the first entity.

Accordingly, the management platform: can calculate risk of each of two entities identified as candidate counterparties. Therefore, the management platform can enable each of the two entities to access a risk associated with the candidate counterparty; and, based on the risk, identify the candidate counterparty as “trusted” or “not trusted”.

### 7.1 Additional Entity Information Request

In one implementation, the management platform can: access a third notification from the first entity requesting additional information (e.g., access to a particular policy) of a second entity; prompt the second entity to provide the additional information; and transmit the additional information to the first entity.

More specifically, the management platform can: generate the second notification specifying the second set of policies in Block S126; transmit the second notification to the first entity in Block S128; access a third notification from the first entity indicating absence of a target policy (e.g., anti-money laundering policy) in the second set of policies, the target policy analogous to a first policy in the first set of policies in Block S102; prompt the second entity to provide the target policy implemented by the second entity in Block S104; access (e.g., receive) a second policy analogous to the first policy from the second entity in Block S106; and transmit the second security policy to the first entity in Block S108.

Accordingly, the management platform can grant a first entity access to a particular policy of a second entity (e.g., upon request). Therefore, the management platform can enable the first entity to verify presence of a set of particular policies in the second set of policies, thereby verifying that the second entity complies with regulatory requirements of the first entity and mitigating risk of establishing a counterparty relationship with the second entity.

### 8. Entity Response+Communication Channel Generation

Based on the second entity information specified in the second notification, the first entity can transmit a first communication—to the management platform—approving the first request to connect the first entity and the second entity via the first communication channel. Similarly, based on the first entity information specified in the first notification, the second entity can transmit a second communication—to the management platform—approving the second request to connect the first entity and the second entity via the first communication channel.

In one implementation, the first entity can: receive—from the management platform—the second notification specifying the second set of policies implemented by the second entity in Block S134; access the first set of policies (implemented by the first entity); access the first target counterparty configuration in Block S132; and generate the first confirmation indicating the second entity as trusted by the first entity in response to detecting presence of the first set of target policies in the second set of policies of the second entity and detecting presence of the second jurisdiction in the first set of target jurisdictions in Block S136. The first entity can then transmit the first confirmation to the management platform in Block S138.

For example, the first entity can access the second notification and access the first target configuration specifying: the first set of target policies (e.g., regulatory requirements, anti-money laundering policies) implemented by entities in a counterparty relationship with the first entity; and the first set of target jurisdictions where the first entity conducts business. Then, the first entity can identify the second entity as trusted in response to detecting presence of the set of target policies in the second set of policies of the second entity and detecting presence of the second jurisdiction in the set of target jurisdictions.

Similarly, the second entity can: receive—from the management platform—the first notification specifying the first set of policies implemented by the first entity; access the second set of policies (implemented by the second entity); access the second target counterparty configuration; generate the second confirmation indicating the first entity as trusted by the second entity in response to detecting presence of the second set of target policies in the first set of policies of the first entity and detecting presence of the first jurisdiction in the second set of target jurisdictions; and transmit the second confirmation to a management network.

Accordingly, a first entity can execute due diligence on another entity (e.g., second entity) based on the first target counterparty configuration generated by the management platform. In response to detecting policies specified in the first target counterparty configuration in the second set of policies of the second entity, the first entity can identify the second entity as a trusted entity and transmit a communication to the management platform indicating the second entity as trusted by the first entity.

### 9. Establishing Communication Channel

The method S100 includes: receiving a first confirmation indicating the second entity as trusted by the first entity based on the second set of policies in Block S130; receiving a second confirmation indicating the first entity as trusted by the second entity based on the first set of policies in Block S132; and generating a communication channel between the first entity and the second entity in response to receiving the first confirmation and the second confirmation in Block S134.

Generally, in Blocks S130, S132, and S134, the management platform can: receive confirmations—from the first entity and the second entity—indicating the candidate counterparty as trusted; and generating a communication channel between the first entity and the second entity in response to receiving these confirmations. Therefore, the management platform can establish the communication channel to: facilitate secure and low-latency communication between entities during runtime execution of a transaction request; and enable the entities to cooperate to comply with sanctions screening requirements in order to complete a regulated transaction.

In one implementation, the management platform: receives the first communication including a first request to connect the first entity and the second entity via a first communication channel between the first entity and the second entity; and receives the second communication including a second request to connect the first entity and the second entity via the first communication channel.

In another implementation, in response to receiving the first communication and the second communication, the management platform can generate the first communication channel—between the first entity and the second entity—through which information (e.g., additional entity information, transaction information) may be exchanged.

More specifically, the management platform can generate the communication channel including: a first interface (e.g., a first application programming interface (hereinafter “API”), a first set of APIs) communicatively coupled to the first entity (e.g., via the first communication link between the management platform and the first entity); and a second interface (e.g., a second API, a second set of APIs) communicatively coupled to the second entity (e.g., via a second communication link between the management platform and the second entity).

In one implementation, the management platform: receives a first set of data from the first entity at the first interface; generates a first message representing the first set of data; and transmits the first message to the second entity via the second interface.

Additionally, the management platform can: receive a second set of data from the second entity at the second interface; generate a second message representing the second set of data; and transmit the second message to the first entity via the first interface.

In another implementation, the management platform generates the first message according to a first messaging protocol—in a set of messaging protocols—associated with the second entity. The management platform also generates the second message according to a second messaging protocol, in the set of messaging protocols, associated with the first entity.

Additionally or alternatively, the management platform encrypts the first set of data, the second set of data, the first message representing the first set of data, and/or the second message representing the second set of data.

Accordingly, the management platform can: generate a secure communication channel between the first entity and the second entity; and manage communication between these entities across this communication channel. Therefore, the management platform enables the first entity and the second entity to share information—securely and according to a protocol(s) compatible with these entities—prior to runtime execution of a transaction request, thereby reducing latency and communication overhead during runtime execution of the transaction request.

### 9.1 Additional Entity Identification & Communication Channels

The management platform can repeat the foregoing methods and techniques: to identify additional entities—in the set of entities—as candidate counterparties to the first entity; to access entity information associated with these entities; and to transmit notifications identifying these entities as candidate counterparties to the first entity and specifying the entity information; and to generate communication channels between the first entity and each of these entities.

Additionally, the management platform can repeat the foregoing methods and techniques for each entity in the set of entities.

### 10. Transaction Data Sharing

Generally, the management platform can manage communication between entities in response to a request to transfer a virtual asset from a first blockchain address to a second blockchain address.

More specifically, the management platform can receive transaction information—from an originator entity (e.g., the first entity) hosting the first blockchain address—associated with the transfer of the virtual asset. Based on the transaction information, the management platform can: identify a beneficiary entity (e.g., the second entity) associated with the second blockchain address; generate a first message representing the transaction information; and transmit the first message to the beneficiary entity. Then, the management platform can: receive a transaction authorization, from the beneficiary entity, accepting the transfer of the virtual asset based on the transaction information; generate a second message indicating acceptance—by the beneficiary entity—of the transfer of the virtual asset; and transmit the second message to the originator entity, which may then transmit a transaction, representing the transfer of the virtual asset, to the distributed network of nodes for commitment to a block of the blockchain.

### 10.1 Transaction Request Generation+Sanctions Screening

In one implementation, a first entity can: receive a user request from a first user associated with the first user identifier, the user request representing the transfer of the virtual asset from the first blockchain address to the second blockchain address in Block S140; and, in response to receiving the user request from the first user, access the list of sanctioned user identifiers in Block S142 and detect absence of the first user identifier in the list of sanctioned user identifiers in Block S144. Accordingly, the first entity can execute sanctions screening on the first user identifier of a first user (e.g., customer of the first entity) that initiated the transfer of the virtual asset.

Then, the first entity can generate the transaction request in Block S146, the transaction request representing a transfer of a virtual asset from a first blockchain address associated with a first user identifier to a second blockchain address and confirming absence of the first user identifier from the list of sanctioned user identifiers. For example, in response to detecting absence of the first user identifier in the list of sanctioned user identifiers, the first entity can generate the transaction request: specifying, at least, the first user identifier, the first blockchain address, the second blockchain address, and a first entity identifier associated with the first entity; and excluding the second user identifier and a second entity identifier associated with the second entity. The first entity can then transmit the transaction request to the management platform (e.g., via the communication channel, via the first interface of the communication channel) in Block S148.

Accordingly, an entity can: execute a sanctions screening of a first user in response to receiving a user request for a transfer of a virtual asset from a blockchain address of the first user to another blockchain address; and transmit—to the management platform—a transaction request representing the transfer of the virtual asset and indicating a sanctions screening status (e.g., passed) of the first user. Therefore, the entity can transmit—to the management platform—transaction information enabling the management platform to identify the counterparty entity for the transaction and transmit the transaction information to the counterparty entity for transaction authorization.

### 10.2 Transaction Request Reception

Block S150 of the method S100 recites receiving a transaction request from the first entity, the transaction request: representing a transfer of a virtual asset from a first blockchain address associated with a first user identifier to a second blockchain address; and confirming absence of the first user identifier from the list of sanctioned user identifiers.

Generally, in Block S150, the management platform can receive the request for a virtual asset transaction between the first blockchain address hosted by the first entity and the second blockchain address hosted by the second entity. Therefore, the management platform can: access the transaction request (e.g., transaction information, first blockchain address, second blockchain address, first entity identifier, first user identifier)—associated with the transaction; and, based on the transaction information, identify the beneficiary entity and facilitate secure exchange of transaction information (e.g., transaction authorization, transaction rejection, transaction confirmation) between the originator entity and the beneficiary entity.

In one implementation, the management platform can receive—from the first entity—the transaction request: representing the transfer of the virtual asset from the first blockchain address associated with the first user identifier to the second blockchain address; confirming absence of the first user identifier from the list of sanctioned user identifiers; and specifying the first entity identifier of the first entity and the first user identifier of the first user.

In one implementation, the management platform can receive the transaction request specifying a first entity identifier (e.g., decentralized entity identifier) associated with the first entity via the first interface of the communication channel, the first interface communicatively coupled to the first entity.

Accordingly, the management platform can receive the transaction request: specifying the originator entity (i.e., first entity), the beneficiary blockchain address (i.e., second blockchain address), and the identification (i.e., first user identifier) of the first user who originated the request; and excluding specification of the beneficiary entity (i.e., second entity) and the identification (i.e., second user identifier) of the second user associated with the second blockchain address.

In another implementation, the originator entity receives a user request, from the first user device associated with the first user, for a transfer of a virtual asset from the first blockchain address—assigned to the first user and hosted by the originator entity—to a second blockchain address. In response to the user request, the originator entity can transmit transaction information associated with the transfer to the management platform. For example, the originator entity—such as the first entity—can transmit the transaction information via an API call to the first interface communicatively coupling the first entity and the management platform.

In another implementation, the management platform receives the transaction information from the originator entity. More specifically, the management platform can receive the transaction information including: a virtual asset type; an amount (or value) of the virtual asset to transfer; an identifier (e.g., a full name) of an originator user (e.g., the first user); an originator blockchain address (e.g., the first blockchain address) associated with the originator user; an identifier (e.g., a decentralized identifier) of an originator entity hosting the originator blockchain address; an identifier of a beneficiary user; a beneficiary blockchain address (e.g., the second blockchain address) associated with the beneficiary user; and an identifier of a beneficiary entity hosting the beneficiary blockchain address.

In one example, the management platform receives the transaction information specifying: the virtual asset type; the amount of the virtual asset to transfer; a first user identifier (e.g., a first full name) of the first user as the originator user; the first blockchain address as the originator blockchain address; a second entity identifier (e.g., a first decentralized identifier) of the first entity as the originator entity; the second user identifier (e.g., a second full name) of the second user as the beneficiary user; the second blockchain address as the beneficiary blockchain address; and/or the second entity identifier (e.g., a second decentralized identifier) of the second entity, hosting the second blockchain address, as the beneficiary entity; etc.

Additionally, the management platform can receive the transaction information confirming absence of the first user identifier—of the first user—from the set of target identifiers (e.g., a list of names of sanctioned users).

In another example, the management platform receives the transaction information excluding the second user identifier of a beneficiary user and/or the second entity identifier of a beneficiary entity hosting the beneficiary blockchain address.

### 10.3 Beneficiary Entity Discovery

Block S160 of the method S100 recites identifying the second entity as associated with the transaction request in response to: the transaction request specifying the second blockchain address; and associating the second blockchain address with the second entity during the first time period.

Accordingly, in Block S160, the management platform can: detect the second blockchain address of the second user in the transaction request; identify the second entity as hosting the second blockchain address; and identify the second entity as associated with the transaction request. Therefore, the management platform can: identify the second entity as the beneficiary entity; and transmit transaction information, including the transaction request, to the second entity as the beneficiary entity.

More specifically, in response to the transaction information (e.g., transaction request) excluding an identifier of the beneficiary entity hosting the beneficiary blockchain address, the management platform can identify the second entity—as the beneficiary entity—based on the beneficiary blockchain address specified in the transaction information. For example, the management platform can: query a set of data repositories storing registration information including sets of blockchain addresses hosted by the set of entities; identify a second data repository, in this set of data repositories, storing the second blockchain address corresponding to the beneficiary blockchain address; and identify the second entity—hosting the second blockchain address—as the beneficiary entity. Additionally, the management platform can identify the second user identifier of the second user as the beneficiary user based on registration information (e.g., the second user identifier) stored in the second repository.

In one implementation, in response to the transaction request excluding an identifier of the second entity (i.e., beneficiary entity) associated with the second blockchain address (i.e., beneficiary blockchain address), the management platform can: extract the second blockchain address from the transaction request; encrypt the second blockchain address as an encrypted target blockchain address; query the database of blockchain addresses for the encrypted target blockchain address; detect correspondence between the encrypted target blockchain address and the encrypted second blockchain address in a record stored in the database of blockchain addresses; and identify the second entity as associated with the transaction request in response to the record representing the encrypted second blockchain address linked to the second entity.

Accordingly, the management platform can: maintain the database of blockchain addresses storing records representing blockchain addresses associated with each entity in the set of entities registered with the management platform. For example, the management platform can maintain the database of blockchain addresses: storing a first record representing an encrypted first blockchain address linked to the first entity; a second record representing the encrypted second blockchain address linked to the second entity; and a third record representing an encrypted third blockchain address linked to the first entity.

Therefore, based on the beneficiary blockchain address and the database of blockchain addresses, the management platform can identify the beneficiary entity associated with a transfer of a virtual asset, enabling the management platform to subsequently transmit transaction information, including the transaction request, to the beneficiary entity.

### 10.4 First Message Generation+Transmission

The method S100 includes: generating a first message based on the transaction request in Block S172; and transmitting the first message to the second entity via the communication channel in Block S174.

In one variation, Block S174 of the method S100 recites transmitting the transaction request to the second entity via the communication channel.

Generally, in Blocks S172 and S174, the management platform can: detect presence of the communication channel between the first entity and the second entity; generate the first message specifying transaction information (included in the transaction request) and the beneficiary entity identifier discovered by the management platform; and transmit the first message to the second entity via the communication channel.

Therefore, in response to presence of the communication channel—representing a trusted counterparty relationship—between the first entity and the second entity, the management platform can transmit the first message to the second entity, thereby enabling the second entity to: securely access transaction information via the communication channel; verify the first entity as trusted; and respond to the transaction request with a transaction authorization or a transaction rejection.

In one implementation, in response to identifying the second entity as associated with the transaction request, the management platform can generate the first message: representing the transfer of the virtual asset from the first blockchain address associated with the first user identifier to the second blockchain address; confirming absence of the first user identifier from the list of sanctioned user identifiers; and specifying the first entity identifier of the first entity, the first user identifier of the first user, and the second entity identifier of the second entity. Then, the management platform can transmit the first message to the second entity (e.g., via the second interface of the communication channel).

In one implementation, the management platform can transmit the first message (or the transaction request) specifying the second entity identifier associated with the second entity (e.g., as the recipient identifier) via the second interface of the communication channel, the second interface communicatively coupled to the second entity.

Accordingly, the management platform can generate the first message specifying: the information specified in the first transaction request; and information accessed by the management platform, such as the beneficiary entity identifier or a risk level associated with the first blockchain address. Therefore, the management platform can enable the second entity to: execute due diligence processes based on the transaction information and/or injected into the first message by the management platform; and accept (or decline) the transfer of the virtual asset based on these due diligence processes.

In one implementation, in response to identifying the second entity as the beneficiary entity, the management platform can: generate a first message representing the transaction information; and transmit the first message to the second entity based on the first communication channel between the first entity and the second entity.

In one implementation, the management platform generates the first message representing the transaction information, such as: the virtual asset type; the amount of the virtual asset to transfer; the first user identifier of the first user as the originator user; the first blockchain address as the originator blockchain address; the first entity identifier of the first entity as the originator entity; the second user identifier of the second user as the beneficiary user; the second blockchain address as the beneficiary blockchain address; and/or the second entity identifier of the second entity, hosting the second blockchain address, as the beneficiary entity; etc.

More specifically, the management platform can generate the first message representing the transaction information according to a second messaging protocol—in a set of messaging protocols—associated with the second entity.

Additionally, the management platform can encrypt the first message as a first encrypted message. Then, the management platform can transmit the first encrypted message to the second entity. For example, the management platform can transmit the first encrypted message to the second entity at the second interface (e.g., a second API) communicatively coupled to the second entity.

Accordingly, by transmitting the first message—representing the transaction information—to the second entity, the management platform enables the second entity: to execute due diligence processes based on the transaction information; and to accept (or decline) the transfer of the virtual asset based on these due diligence processes. Therefore, the management platform enables the second entity to comply with policies for sanctions screening and/or transaction recordkeeping.

### 10.4.1 First Message Augmentation

In one implementation, the management platform generates the first message including additional information, such as risk level associated with the first entity, the first blockchain address, and/or the second blockchain address.

For example, the management platform can generate the first message specifying a first risk level (or score) of the first entity, a second risk level (or score) of the first blockchain address, and/or a third risk level (or score) of the first user. In this example, the management platform can access the first risk level, the second risk level, and/or the third risk level from a data repository—of the management platform—associated with the first entity. Additionally or alternatively, the management platform can access (or calculate) the first risk level, the second risk level, and/or the third risk level based on information stored in an external database.

### 10.5 Transaction Authorization Generation+Sanctions Screening

Generally, in response to receiving the first message representing the transaction information, the second entity can accept (or decline) the transfer of the virtual asset based on the transaction information.

In one implementation, the second entity: accesses, from the first message, the second blockchain address; and, based on the second blockchain address, accesses—from a second user database—the second user identifier, of the second user, to which the second blockchain address is assigned. Additionally, or alternatively, the second entity can access the second user identifier of the second user from the first message.

The second entity then: accesses a set of target identifiers (e.g., list of names of sanctioned users); and, in response to absence of the second user identifier of the second user from the set of target users, generates a second message accepting the transfer of the virtual asset based on the transaction information. However, in response to presence of the second user identifier—of the second user—in the set of target users, the second entity can generate the second message declining the transfer of the virtual asset.

Additionally, the second entity can generate the second message specifying absence (or presence) of the second user identifier—of the second user—in the set of target users.

In another implementation, the second entity can generate the second message accepting (or declining) the transfer of the virtual asset based on: the transaction information confirming absence of the first user identifier—of the first user—from the set of target identifiers; the first risk level of the first entity; the second risk level of the first blockchain address; and/or the third risk level of the first user.

The second entity can transmit the second message to the management platform via the second interface.

In another implementation, in Block S152, the second entity can receive the transaction request—from the management platform (e.g., via the second interface)—specifying: the second blockchain address; and absence of the first user identifier from the list of sanctioned user identifiers. Accordingly, the second entity can receive the transaction request specifying, at least, the second blockchain address of the beneficiary user, the first blockchain address of the originator user, and absence of the first user identifier from the list of sanctioned user identifiers.

The second entity can then: identify the second user identifier as associated with the second blockchain address (e.g., based on a user database) in Block S154; access the list of sanctioned user identifiers in Block S156; and detect absence of the second user identifier in the list of sanctioned user identifiers in Block S158. Accordingly, the second entity can: identify the second user identifier as the identifier of the beneficiary user based on the second blockchain address; and execute sanctions screening of the second user identifier.

In this implementation, the second entity also can: generate the transaction authorization in response to absence of the first user identifier in the list of sanctioned user identifiers, absence of the second user identifier in the list of sanctioned user identifiers, and identification of the first entity as trusted by the second entity during the first time period in Block S162; and transmit the transaction authorization via the communication channel (e.g., via the second interface of the communication channel) to the management platform in Block S164.

Accordingly, the second entity can generate the transaction authorization in response to: detecting a trusted counterparty relationship between the first entity and the second entity; and satisfaction of a set of conditions (e.g., absence of the first and second user identifier from the list of sanctioned user identifiers, transaction amount falling below a threshold amount, first risk level of the first blockchain address falling below a threshold risk level, etc.) set by the second entity.

Therefore, the second entity can cooperate with the management platform to execute due diligence processes based on the first message received from the management platform and accept (or decline) the transfer of the virtual asset based on these due diligence processes.

### 10.5.1 Transaction Rejection

In one variation, the second entity can: receive the first message specifying, at least, the second blockchain address as the blockchain address of a beneficiary user; identify the second user identifier as associated with the second blockchain address (e.g., based on a user database); access the list of sanctioned user identifiers; and detect presence of the second user identifier in the list of sanctioned user identifiers. Accordingly, the second entity can: identify the second user identifier as the identifier of the beneficiary user based on the second blockchain address; and detect the second user identifier in the list of sanctioned user identifiers, indicating that the second user is sanctioned (e.g., by the second entity, by a jurisdiction of the second entity).

In this variation, the second entity can also: generate a transaction rejection in response to presence of the second user identifier in the list of sanctioned user identifiers. Additionally, or alternatively, the second entity can generate the transaction rejection: in response to presence of the first user identifier in the list of sanctioned user identifiers; and/or in response to identification of the first entity as “not trusted” by the second entity during the first time period. Then, the second entity can transmit the transaction rejection via the communication channel to the management platform.

Accordingly, the second entity can generate the transaction rejection in response to: detecting absence of a trusted counterparty relationship between the first entity and the second entity; and/or failure of the first user or the second user to comply with sanctions screening requirements.

Therefore, the second entity can cooperate with the management platform to execute due diligence processes based on the first message received from the management platform and decline the transfer of the virtual asset based on these due diligence processes.

### 10.6 Transaction Authorization Reception

Block S180 of the method S100 recites receiving the transaction authorization from the second entity, the transaction authorization: indicating acceptance of the transfer of the virtual asset by the second entity based on absence of the first user identifier from the list of sanctioned user identifiers; and confirming absence of a second user identifier, associated with the second blockchain address, from the list of sanctioned user identifiers.

Generally, in Block S180, the management platform can detect (or access) authorization of the transaction of the virtual asset between the first blockchain address hosted by the first entity and the second blockchain address hosted by the second entity.

Therefore, the management platform can: access a transaction authorization associated with the transaction; and based on the transaction authorization, execute additional verification processes prior to transmitting an indication of transaction authorization to the first entity.

For example, prior to transmitting an indication of transaction authorization to the first entity, the management platform can: verify that the first entity and the second entity executed sanctions screening; and/or verify absence of the first user identifier and the second user identifier from the list of sanctioned user identifiers; and/or verify that a total risk level (e.g., cumulative risk level for the first blockchain address, the second blockchain address, the first entity identifier, and the second entity identifier) associated with the transaction falls below a risk threshold.

In one implementation, the management platform can: receive the transaction authorization specifying the second entity identifier associated with the second entity (e.g., as an identifier of the sender of the transaction authorization) via the second interface of the communication channel, the second interface communicatively coupled to the second entity.

In one implementation, the management platform can receive—from the second entity—the transaction authorization: indicating acceptance of the transfer of the virtual asset by the second entity based on absence of the first user identifier from the list of sanctioned user identifiers; confirming absence of a second user identifier, associated with the second blockchain address, from the list of sanctioned user identifiers; and specifying the first entity identifier, the first user identifier, the second entity identifier, and the second user identifier of the second user.

Then, the management platform can: detect confirmation of absence of the first user identifier in the list of sanctioned user identifiers based on the transaction request; and detect confirmation of absence of the second user identifier in the list of sanctioned user identifiers based on the transaction authorization.

Accordingly, based on the transaction authorization (and the transaction request), the management platform can: verify that the first entity and the second entity executed sanctions screening; and/or verify absence of the first user identifier and the second user identifier from the list of sanctioned user identifiers. Therefore, based on the transaction authorization, the management platform can execute additional verification processes prior to transmitting an indication of transaction authorization to the first entity.

### 10.6.1 Transaction Rejection Reception

In one variation, Block S185 of the method S100 recites: receiving a transaction rejection from the second entity, the transaction rejection indicating rejection of the transfer of the virtual asset by the second entity based on presence of the second user identifier in the list of sanctioned user identifiers.

In Block S185, the management platform can detect (or access) rejection of the transaction of the virtual asset between the first blockchain address hosted by the first entity and the second blockchain address hosted by the second entity. Therefore, the management platform can cooperate with the second entity to execute sanctions screening of the second user identifier of the beneficiary user.

### 10.7 Second Message Generation+Transmission

The method S100 includes: generating a second message based on the transaction authorization in Block S182; and transmitting the second message to the first entity via the communication channel in Block S184.

In one variation, Block S184 of the method S100 recites transmitting the transaction authorization to the first entity via the communication channel.

Generally, in Blocks S182 and S184, the management platform can: generate the second message, representing the transaction authorization, and transmit the message to the first entity (e.g., via the first interface). Therefore, the management platform can transmit the second message to the first entity, thereby enabling the first entity to: securely access transaction authorization via the communication channel; verify the transaction complies with regulatory requirements (e.g., sanctions screening policies); and submit (or transmit) the transaction for commitment to a block of the blockchain.

In one implementation, the management platform can transmit the second message (or the transaction authorization) specifying the first entity identifier associated with the first entity (e.g., as the recipient identifier) via the first interface of the communication channel, the first interface communicatively coupled to the first entity.

In one implementation, in response to detecting confirmation of absence of the first user identifier in the list of sanctioned user identifiers and detecting confirmation of absence of the second user identifier in the list of sanctioned user identifiers, the management platform can generate a second message: indicating acceptance of the transfer of the virtual asset by the second entity based on absence of the first user identifier from the list of sanctioned user identifiers; indicating sanctions screening completion by the first entity and the second; and indicating absence of the first user identifier and the second user identifier from the list of sanctioned user identifiers.

Accordingly, the management platform can: execute additional verification of the transaction, such as detecting confirmation of absence of the first user identifier in the list of sanctioned user identifiers based on the transaction request and detecting confirmation of absence of the second user identifier in the list of sanctioned user identifiers based on transaction authorization; generate the second message representing transaction authorization in response to verifying the transaction; and transmit the second message to the first management platform. Therefore, the management platform cooperates with the first entity to execute additional verification of the transaction prior to transmission of the transaction to the distributed network of nodes for commitment to a block of the blockchain.

In one implementation, the management platform: receives the transaction authorization, from the second entity, accepting the transfer of the virtual asset; generates a second message indicating acceptance—by the second entity—of the transfer of the virtual asset; and transmits the second message to the originator entity, such as via the first interface.

More specifically, the management platform can generate: the second message including: the second user identifier of the second user as the beneficiary user; the second blockchain address as the beneficiary blockchain address; and the second entity identifier of the second entity, hosting the second blockchain address, as the beneficiary entity. Additionally, the management platform can generate the second confirming absence of the second user identifier—of the second user—from the set of target identifiers. The management platform can generate the second including additional information, such as a fourth risk level (or score) of the second entity, a fifth risk level (or score) of the second blockchain address, and/or a sixth risk level (or score) of the second user.

In another implementation, the management platform generates the second message according to a first messaging protocol—in the set of messaging protocols—associated with the first entity and/or encrypts the second message.

In one implementation, in response to receiving the second message indicating acceptance—by the second entity—of the transfer of the virtual asset, the first entity: generates a transaction representing the transfer of the virtual asset from the first blockchain address to the second blockchain address; and transmits the transaction to the distributed network of nodes for commitment to a block of the blockchain.

More specifically, the first entity can transmit the transaction in response to the second message: indicating acceptance, by the second entity, of the transfer of the virtual asset; and confirming absence of the second user identifier—of the second user—from the set of target identifiers.

Accordingly, based on the second message, the management platform can: identify—to the first entity—the second user identifier of the second user and/or the second entity identifier of the second entity; and confirm, to the first entity, absence of the second user identifier of the second user from the set of target identities. Therefore, the management platform enables the first entity to comply with policies for transaction recordkeeping and/or sanctions screening.

### 10.7.1 Transaction Rejection Transmission to First Entity

In one variation, Block S184 of the method S100 recites transmitting the transaction rejection to the first entity via the communication channel.

Generally, in Block S184, the management platform can transmit the transaction rejection to the originator entity in response to receiving the transaction request from the beneficiary entity. Additionally, or alternatively, in Block S195, the management platform: generates a fourth message (e.g., according to the first messaging protocol associated with the originator entity) indicating rejection—by the beneficiary entity—of the transfer of the virtual asset; and transmits the fourth message to the originator entity. Therefore, the management platform can cooperate with the first and second entity to transmit an indication of the transaction request to the first entity.

### 10.7.2 Risk Evaluation & Additional Verification

In one implementation, the management platform accesses a set of risk levels, such as: the first risk level of the first entity; the second risk level of the first blockchain address; the third risk level of the first user; the fourth risk level of the second entity; the fifth risk level of the second blockchain address; and/or the sixth risk level of the second user. In this implementation, the management platform can generate the second message—indicating acceptance, by the second entity and the management platform, of the transfer of the virtual asset—in response to the set of risk levels falling below a risk level threshold(s). The first entity can transmit the transaction to the distributed network of nodes in response to the second message indicating acceptance, by the second entity and the management platform, of the transfer of the virtual asset.

Alternatively, the management platform can generate the second message representing an error (or exception) in response to one risk level—in the set of risk levels—falling below the risk level threshold(s).

Additionally or alternatively, the management platform can: access the first user identifier of the first user and the second user identifier of the second user; access the set of target identifiers (e.g., the list of names of sanctioned users); and generate the second message—indicating acceptance, by the second entity and the management platform, of the transfer of the virtual asset—in response to absence of the first user identifier of the first user and the second user identifier of the second user from the set of target identifiers.

Alternatively, the management platform can generate the second message representing an error (or exception) in response to the set of target identifiers including the first user identifier of the first user and/or the second user identifier of the second user.

Accordingly, the management platform can: execute a sanctions screening of the originating user and/or the beneficiary user; and evaluate risk of the transfer based on risk of the originator blockchain address, originator user, the originator entity, the beneficiary blockchain address, the beneficiary user, and/or the beneficiary entity. Therefore, the management platform implements an additional layer of security and diligence to ensure compliance with sanctions screening policies and to further reduce risk (e.g., anti-money-laundering risk) exposure of these entities.

### 10.8 Transaction Submission+Confirmation Generation

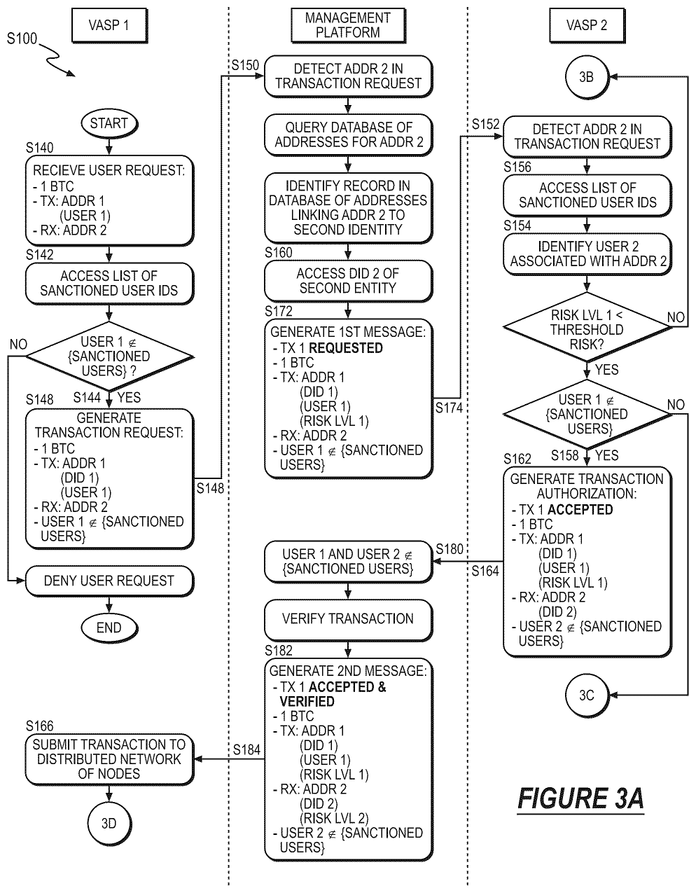

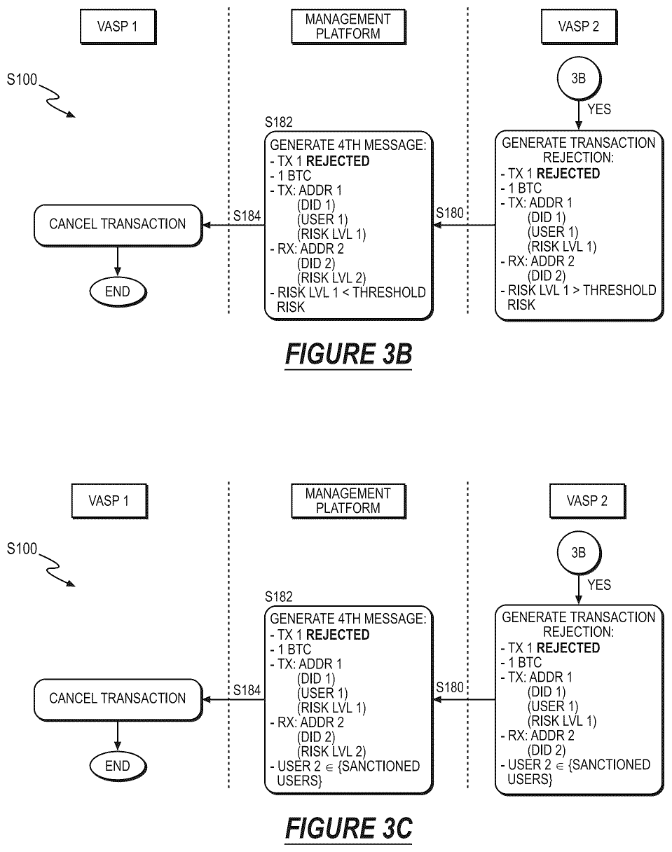

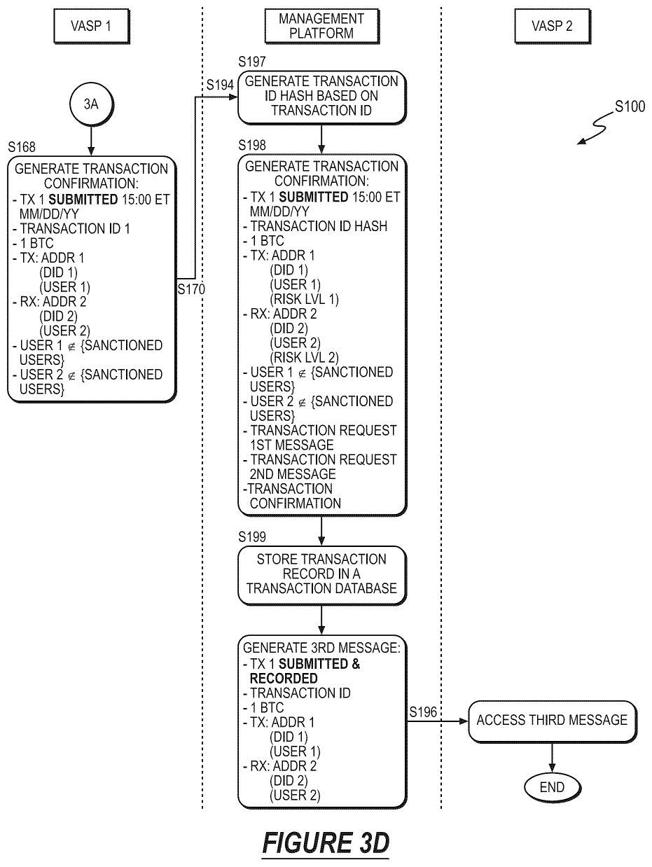

In one implementation, shown in FIGS. 3A and 3D, the first entity can submit a blockchain transaction to a distributed network of nodes for commitment to a block of a blockchain in response to receiving the transaction authorization from the management platform in Block S166. Then, the first entity can: generate a transaction confirmation indicating transmission of the blockchain transaction—representing the transfer of the virtual asset from the first blockchain address to the second blockchain address—to the distributed network for commitment to the block of the blockchain and specifying a transaction identifier associated with the blockchain transaction in Block S168; and transmit the transaction confirmation to the management platform and/or the second entity via the communication channel (e.g., via the first interface of the communication channel) in Block S170.

Accordingly, in response to receiving transaction authorization via the communication channel, the originator entity can submit the blockchain transaction for commitment to the block of the blockchain. After the transaction is submitted, the originator entity can: generate a transaction confirmation confirming submission of the blockchain transaction; and transmit the transaction confirmation to the management platform for recording in a transaction database and/or transmission to the beneficiary entity. Therefore, the originator entity can cooperate with the management platform to: securely transmit an indication of the transaction confirmation to the beneficiary entity; and create an auditable record of the blockchain transaction.

### 10.9 Transaction Confirmation Reception

Generally, as shown in FIG. 3D, the management platform can: receive—from the first entity—the transaction confirmation indicating submission of a blockchain transaction to the distributed network for commitment to a block of the blockchain in Block S194; and transmit the transaction confirmation to the second entity via the communication channel (e.g., via the second interface of the communication channel) in Block S196.

For example, the management platform can receive—from the first entity—the transaction confirmation specifying: the transaction identifier (or a transaction identifier hash) of the blockchain transaction; the first blockchain address as the originator address; the second blockchain address as the beneficiary address; the first user identifier as the originator user identifier; the second user identifier as the beneficiary user identifier; a transaction timestamp; and the amount of the virtual asset transferred.

In one implementation, in Block S194, the management platform can generate a third message: indicating submission of a blockchain transaction—representing the transfer of the virtual asset from the first blockchain address to the second blockchain address—to a distributed network for commitment to a block of a blockchain; and specifying the transaction identifier (or the transaction identifier hash) associated with the blockchain transaction, and the transaction timestamp. Then, the management platform can transmit the third message to the second entity.

Additionally, or alternatively, the management platform can: generate a transaction identifier hash based on the transaction identifier and a cryptographic hash function in Block S197; and, in response to receiving the transaction confirmation, generate the third message in Block S194, the third message indicating submission of a blockchain transaction to the distributed network for commitment to a block of a blockchain and specifying the transaction identifier and/or the transaction identifier hash. Accordingly, the management platform can generate and transmit to the second entity, the third message: specifying the transaction confirmation; and including additional information injected by the management platform, such as the transaction identifier hash.

Therefore, the management platform can transmit an indication of the transaction confirmation to the beneficiary entity, enabling the beneficiary entity to confirm completion of the transaction and further confirm a status of the first entity as “trusted.”

In another implementation, the management platform generates a third message representing the transaction confirmation according to the second messaging protocol—in the set of messaging protocols—associated with the second entity and/or encrypts the third message. Then, the management platform transmits the third message representing the transaction confirmation to the second entity.

Accordingly, based on the transaction confirmation, the management platform can: obtain the transaction identifier for recordkeeping; and notify the second entity of submission of the blockchain transaction.

### 10.9.1 Management Platform Signature

In one implementation, the management platform can: access the transaction representing the transfer of the virtual asset, such as receiving the transaction from the first entity in Block S186; and update the transaction—to include a signature associated with the management platform—as a signed transaction in Block S190. More specifically, the management platform can update the transaction—including the signature associated with the management platform—in response to: the set of risk levels falling below the risk level threshold(s); and/or absence of the first user identifier of the first user and the second user identifier of the second user from the set of target identifiers.

In this implementation, in response to updating the transaction as the signed transaction, the management platform can transmit the signed transaction to the first entity in Block S192, which may then transmit the signed transaction to the distributed network of nodes for commitment to a block of the blockchain. Additionally or alternatively, the management platform can transmit the signed transaction to the distributed network of nodes for commitment to the block of the blockchain.

In another implementation, the management platform can: access a blockchain transaction representing the transfer of the virtual asset from the first blockchain address to the second blockchain address in Block S186; and, in response to absence of the first user identifier and the second user identifier in the list of sanctioned user identifiers, update the blockchain transaction as a verified transaction in Block S188 and cryptographically sign the verified transaction in Block S190. Then, the management platform can: submit the verified transaction to a distributed network of nodes for commitment to a block of a blockchain in Block S192. Alternatively, after cryptographically signing the verified transaction, the management platform can transmit the signed transaction to the first entity, which may then submit the signed transaction to the distributed network of nodes for commitment to a block of the blockchain.

Accordingly, the management platform can verify and cryptographically sign the blockchain transaction prior to its submission. Therefore, the management platform can authenticate the transaction as legitimate and/or regulated for recordation in the block of the blockchain, thereby enabling an observer of the blockchain to later validate the transaction as verified by the management platform.

### 11. Transaction Recordkeeping

In one implementation, the management platform generates a record representing: the transaction information; acceptance (or declination) of the transfer by the beneficiary entity; and/or verification (or exception) by the management platform. The management platform can: encrypt the record; and store the record in a transaction database.

In another implementation, shown in FIG. 3D, after receiving the transaction confirmation from the first entity, the management platform can: extract the transaction identifier from the transaction confirmation; generate a transaction identifier hash based on the transaction identifier and a cryptographic hash function in Block S197; and generate a record associated with the blockchain transaction in Block S98. The record represents: completion of the transfer of the virtual asset from the first blockchain address—associated with the first user identifier—to the second blockchain address associated with the second user identifier; absence of the first user identifier and the second user identifier from the list of sanctioned user identifiers; the transaction identifier hash; and a set of transaction communications including the transaction request, the transaction authorization (or transaction rejection), the transaction confirmation, etc. The management platform can then store the record in the transaction database in Block S199.

The management platform can repeat the foregoing methods and techniques to generate and store—in the transaction database—records of additional blockchain transactions associated with entities in the set of entities.

Accordingly, the management platform can log: transaction data including entity identifiers, blockchain addresses, user identifiers, user sanctions screening statuses, virtual asset amounts; and communications—including transaction requests, authorizations, confirmations—transmitted between entities and/or the management platform. Therefore, the management platform can generate a historical record of blockchain transactions enabling entities, individuals, and/or regulators to review, investigate, or audit transfer of virtual assets. Furthermore, the management platform can grant access to the historical record of blockchain transactions in order to enable users to prove ownership of virtual assets transacted and resolve disputes.

### 12. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a first time period:
accessing a first set of policies implemented by a first entity;
accessing a second set of policies implemented by a second entity;
identifying the second entity as a candidate counterparty to the first entity based on correspondence between the first set of policies and the second set of policies;
generating a first notification specifying the first set of policies;
transmitting the first notification to the second entity;
generating a second notification specifying the second set of policies;
transmitting the second notification to the first entity;
receiving a first confirmation indicating the second entity as trusted by the first entity based on the second set of policies;
receiving a second confirmation indicating the first entity as trusted by the second entity based on the first set of policies; and
generating a communication channel between the first entity and the second entity in response to receiving the first confirmation and the second confirmation; and
during a second time period:
receiving a transaction request from the first entity, the transaction request:
representing a transfer of a virtual asset from a first blockchain address associated with a first user identifier to a second blockchain address; and
confirming absence of the first user identifier from a list of sanctioned user identifiers;
identifying the second entity as associated with the transaction request in response to:
associating the second blockchain address with the second entity during the first time period; and
the transaction request specifying the second blockchain address;
transmitting the transaction request to the second entity via the communication channel;
receiving a transaction authorization from the second entity, the transaction authorization:
indicating acceptance of the transfer of the virtual asset by the second entity based on absence of the first user identifier from the list of sanctioned user identifiers; and
confirming absence of a second user identifier, associated with the second blockchain address, from the list of sanctioned user identifiers; and
transmitting the transaction authorization to the first entity via the communication channel.

2. The method of claim 1, further comprising:
receiving a transaction confirmation from the first entity, the transaction confirmation:
indicating submission of a blockchain transaction, representing the transfer of the virtual asset from the first blockchain address to the second blockchain address, to a distributed network for commitment to a block of a blockchain; and
specifying a transaction identifier associated with the blockchain transaction;
transmitting the transaction confirmation to the second entity via the communication channel;
generating a transaction identifier hash based on the transaction identifier and a cryptographic hash function;
generating a record representing:
completion of the transfer of the virtual asset from the first blockchain address, associated with the first user identifier, to the second blockchain address associated with the second user identifier;
absence of the first user identifier and the second user identifier from the list of sanctioned user identifiers;
the transaction identifier hash; and
the transaction request, the transaction authorization, and the transaction confirmation; and
storing the record in a transaction database.

3. The method of claim 2:
wherein receiving the transaction request from the first entity comprises receiving the transaction request from the first entity, the transaction request specifying:
a first entity identifier of the first entity; and
the first user identifier associated with the first blockchain address;
wherein transmitting the transaction request to the second entity via the communication channel comprises:
in response to identifying the second entity as associated with the transaction request, generating a first message:
representing the transfer of the virtual asset from the first blockchain address to the second blockchain address;
confirming absence of the first user identifier from the list of sanctioned user identifiers; and
specifying:
the first entity identifier;
the first user identifier; and
a second entity identifier of the second entity; and
transmitting the transaction request comprising the first message to the second entity via the communication channel;
wherein receiving the transaction authorization from the second entity comprises receiving the transaction authorization from the second entity, the transaction authorization specifying:
the first entity identifier;
the first user identifier;
the second entity identifier; and
a second user identifier associated with the second blockchain address;
wherein transmitting the transaction authorization to the first entity via the communication channel comprises:
detecting confirmation of absence of the first user identifier in the list of sanctioned user identifiers based on the transaction request;
detecting confirmation of absence of the second user identifier in the list of sanctioned user identifiers based on the transaction authorization;
in response to detecting confirmation of absence of the first user identifier in the list of sanctioned user identifiers and detecting confirmation of absence of the second user identifier in the list of sanctioned user identifiers, generating a second message:
indicating acceptance of the transfer of the virtual asset by the second entity based on absence of the first user identifier from the list of sanctioned user identifiers;
indicating sanctions screening completion by the first entity and the second entity; and
indicating absence of the first user identifier and the second user identifier from the list of sanctioned user identifiers; and
transmitting the transaction authorization comprising the second message to the first entity via the communication channel;
wherein transmitting the transaction confirmation to the second entity via the communication channel comprises:
generating a third message:
indicating submission of the blockchain transaction, representing the transfer of the virtual asset from the first blockchain address to the second blockchain address, to the distributed network for commitment to the block of the blockchain; and
specifying:
the transaction identifier associated with the blockchain transaction;
the transaction identifier hash; and
transmitting the transaction confirmation comprising the third message to the second entity via the communication channel; and
wherein generating the record comprises generating the record representing the transaction request, the first message, the transaction authorization, the second message, and the transaction confirmation, and the third message.

4. The method of claim 1:
wherein accessing the first set of policies implemented by the first entity comprises:
accessing the first set of policies implemented by the first entity; and
based on the first set of policies, generating a target counterparty configuration for the first entity, the target counterparty configuration representing a set of target policies and a set of target jurisdictions characterizing a target entity trusted by the first entity;
wherein accessing the second set of policies implemented by the second entity comprises:
accessing the second set of policies implemented by the second entity; and
accessing a second jurisdiction of the second entity; and
wherein generating the first notification specifying the second set of policies comprises generating the first notification specifying the second set of policies and indicating compliance of the second set of policies of the second entity and the second jurisdiction of the second entity with the target counterparty configuration of the first entity in response to:
detecting presence of the set of target policies in the second set of policies of the second entity; and
detecting presence of the second jurisdiction in the set of target jurisdictions.

5. The method of claim 1:
wherein generating the second notification specifying the second set of policies comprises generating the second notification specifying the second set of policies and a second jurisdiction of the second entity;
wherein transmitting the second notification to the first entity comprises transmitting the second notification specifying the second set of policies and the second jurisdiction to the first entity;
wherein accessing the first set of policies implemented by the first entity comprises:
accessing the first set of policies implemented by the first entity; and
based on the first set of policies, generating a target counterparty configuration for the first entity, the target counterparty configuration representing a set of target policies and a set of target jurisdictions characterizing a target entity trusted by the first entity; and
further comprising, during the first time period:
at the first entity:
accessing the target counterparty configuration;
receiving the second notification specifying the second set of policies implemented by the second entity;
generating the first confirmation indicating the second entity as trusted by the first entity based on the second set of policies in response to:
detecting presence of the set of target policies in the second set of policies of the second entity; and
detecting presence of the second jurisdiction in the set of target jurisdictions; and
transmitting the first confirmation to a management network.

6. The method of claim 1, further comprising, during the first time period:
accessing a third notification from the first entity indicating absence of a target anti-money laundering policy in the second set of policies, the target anti-money laundering policy analogous to a first anti-money laundering policy in the first set of policies;
prompting the second entity to specify the target anti-money laundering policy implemented by the second entity;
receiving a second anti-money laundering policy analogous to the first anti-money laundering policy from the second entity; and
transmitting the second anti-money laundering policy to the first entity.

7. The method of claim 1:
wherein accessing the first set of policies implemented by the first entity comprises accessing the first set of policies implemented by the first entity, the first set of policies comprising a first sanctions screening policy associated with the list of sanctioned user identifiers;
wherein accessing the second set of policies implemented by the second entity comprises accessing the second set of policies implemented by the second entity, the second set of policies comprising a second sanctions screening policy associated with the list of sanctioned user identifiers;
wherein generating the first notification specifying the first set of policies comprises generating the first notification specifying the first set of policies comprising the first sanctions screening policy;
wherein generating the second notification specifying the second set of policies comprises generating the second notification specifying the second set of policies comprising the second sanctions screening policy; and
wherein identifying the second entity as the candidate counterparty to the first entity based on correspondence between the first set of policies and the second set of policies comprises identifying the second entity as the candidate counterparty to the first entity based on the first sanctions screening policy, in the first set of policies, matching the second sanctions screening policy in the second set of policies.

8. The method of claim 1:
wherein accessing the second set of policies implemented by the second entity comprises:
receiving the second blockchain address associated with the second entity;
encrypting the second blockchain address into an encrypted second blockchain address;
generating a record representing the encrypted second blockchain address linked to the second entity; and
storing the record in a database of blockchain addresses; and
wherein identifying the second entity as associated with the transaction request comprises:
extracting the second blockchain address from the transaction request;
encrypting the second blockchain address as an encrypted target blockchain address;
querying the database of blockchain addresses for the encrypted target blockchain address;
detecting correspondence between the encrypted target blockchain address and the encrypted second blockchain address in the record; and
identifying the second entity as associated with the transaction request in response to the record representing the encrypted second blockchain address linked to the second entity.

9. The method of claim 1:
wherein generating the communication channel between the first entity and the second entity comprises generating the communication channel between the first entity and the second entity, the communication channel comprising:
a first interface communicatively coupled to the first entity via a first communication link; and
a second interface communicatively coupled to the second entity via a second communication link;
wherein receiving the transaction request from the first entity comprises receiving the transaction request specifying a first entity identifier associated with the first entity via the first interface;
wherein transmitting the transaction request to the second entity via the communication channel comprises transmitting the transaction request specifying a second entity identifier associated with the second entity via the second interface of the communication channel;
wherein receiving the transaction authorization from the second entity comprises receiving the transaction authorization specifying the second entity identifier associated with the second entity via the second interface; and
wherein transmitting the transaction authorization to the first entity via the communication channel comprises transmitting the transaction authorization specifying the first entity identifier associated with the first entity via the first interface of the communication channel.

10. The method of claim 1, further comprising, during the second time period:
at the first entity:
receiving a user request from a first user associated with the first user identifier, the user request representing the transfer of the virtual asset from the first blockchain address to the second blockchain address; and
in response to receiving the user request from the first user:
accessing the list of sanctioned user identifiers;
detecting absence of the first user identifier in the list of sanctioned user identifiers;
generating the transaction request:
specifying the first user identifier and a first entity identifier associated with the first entity; and
excluding the second user identifier and a second entity identifier associated with the second entity; and
transmitting the transaction request via the communication channel.

11. The method of claim 1, further comprising, during the second time period:
at the first entity:
in response to receiving the transaction authorization via the communication channel, transmitting a blockchain transaction to a distributed network of nodes for commitment to a block of a blockchain;
generating a transaction confirmation:
indicating transmission of the blockchain transaction, representing the transfer of the virtual asset from the first blockchain address to the second blockchain address, to the distributed network for commitment to the block of the blockchain; and
specifying a transaction identifier associated with the blockchain transaction; and
transmitting the transaction confirmation via the communication channel.

12. The method of claim 1:
further comprising:
calculating a first risk level for the first entity based on the first set of policies; and
calculating a second risk level for the second entity based on the second set of policies;
wherein generating the first notification specifying the first set of policies comprises generating the first notification specifying the first set of policies and the first risk level of the first entity; and
wherein generating the second notification specifying the second set of policies comprises generating the second notification specifying the second set of policies and the second risk level of the second entity.

13. The method of claim 1, further comprising:
receiving a blockchain transaction representing the transfer of the virtual asset from the first blockchain address to the second blockchain address;
in response to absence of the first user identifier and the second user identifier in the list of sanctioned user identifiers:
updating the blockchain transaction as a verified transaction; and
cryptographically signing the verified transaction; and
submitting the verified transaction to a distributed network of nodes for commitment to a block of a blockchain.

14. The method of claim 1, further comprising, during the second time period:
at the second entity:
receiving the transaction request via the communication channel, the transaction request specifying:
the second blockchain address; and
absence of the first user identifier from the list of sanctioned user identifiers;
identifying the second user identifier as associated with the second blockchain address;
accessing the list of sanctioned user identifiers;
detecting absence of the second user identifier in the list of sanctioned user identifiers;
generating the transaction authorization in response to:
absence of the first user identifier in the list of sanctioned user identifiers;
absence of the second user identifier in the list of sanctioned user identifiers; and
identification of the first entity as trusted by the second entity; and
transmitting the transaction authorization via the communication channel.

15. A method comprising:
during a first time period:
accessing a first set of policies implemented by a first entity;
accessing a second set of policies implemented by a second entity;
identifying the second entity as a candidate counterparty to the first entity based on correspondence between the first set of policies and the second set of policies;
generating a first notification specifying the second set of policies;
transmitting the first notification to the first entity;
generating a second notification specifying the first set of policies;
transmitting the second notification to the second entity;
receiving a first confirmation indicating the second entity as trusted by the first entity based on the second set of policies;
receiving a second confirmation indicating the first entity as trusted by the second entity based on the first set of policies; and
generating a communication channel between the first entity and the second entity in response to receiving the first confirmation and the second confirmation; and
during a second time period:
receiving a transaction request from the first entity, the transaction request:
representing a transfer of a virtual asset from a first blockchain address associated with a first user identifier to a second blockchain address; and
confirming absence of the first user identifier from a list of sanctioned user identifiers;
identifying the second entity as associated with the transaction request in response to:
associating the second blockchain address with the second entity during the first time period; and
the transaction request specifying the second blockchain address;
generating a message representing the transaction request;
transmitting the message to the second entity via the communication channel;
receiving a transaction rejection from the second entity, the transaction rejection indicating rejection of the transfer of the virtual asset by the second entity based on presence of a second user identifier, associated with the second blockchain address, in the list of sanctioned user identifiers; and
transmitting the transaction rejection to the first entity via the communication channel.

16. The method of claim 15, further comprising, during the second time period:
at the second entity:
receiving the transaction request via the communication channel, the transaction request specifying:
the second blockchain address; and
absence of the first user identifier from the list of sanctioned user identifiers;
identifying the second user identifier as associated with the second blockchain address;
accessing the list of sanctioned user identifiers;
detecting presence of the second user identifier in the list of sanctioned user identifiers;
generating the transaction rejection in response to presence of the second user identifier in the list of sanctioned user identifiers; and
transmitting the transaction rejection via the communication channel.

17. The method of claim 15:
further comprising:
calculating a first risk level for the first entity based on the first set of policies; and
calculating a second risk level for the second entity based on the second set of policies;
wherein generating the first notification specifying the first set of policies comprises generating the first notification specifying the first set of policies and the first risk level of the first entity; and
wherein generating the second notification specifying the second set of policies comprises generating the second notification specifying the second set of policies and the second risk level of the second entity.

18. The method of claim 15:
wherein accessing the first set of policies implemented by the first entity comprises:
accessing the first set of policies implemented by the first entity; and
based on the first set of policies, generating a target counterparty configuration for the first entity, the target counterparty configuration representing a set of target policies and a set of target jurisdictions characterizing a target entity trusted by the first entity;
wherein accessing the second set of policies implemented by the second entity comprises:
accessing the second set of policies implemented by the second entity; and
accessing a second jurisdiction of the second entity; and
wherein generating the first notification specifying the second set of policies comprises generating the first notification specifying the second set of policies and indicating compliance of the second set of policies of the second entity and the second jurisdiction of the second entity with the target counterparty configuration of the first entity in response to:
detecting presence of the set of target policies in the second set of policies of the second entity; and
detecting presence of the second jurisdiction in the set of target jurisdictions.

19. A method comprising:
during a first time period:
receiving a first set of policies implemented by a first virtual asset service provider;
receiving a second set of policies implemented by a second virtual asset service provider;
identifying the second virtual asset service provider as a candidate counterparty to the first virtual asset service provider based on correspondence between the first set of policies and the second set of policies;
granting access of the second set of policies to the first virtual asset service provider;
granting access of the first set of policies to the second virtual asset service provider;
receiving a first confirmation indicating the second virtual asset service provider as trusted by the first virtual asset service provider based on the second set of policies;
receiving a second confirmation indicating the first virtual asset service provider as trusted by the second virtual asset service provider based on the first set of policies; and
generating a communication channel between the first virtual asset service provider and the second virtual asset service provider in response to receiving the first confirmation and the second confirmation; and
during a second time period:
receiving a transaction request from the first virtual asset service provider, the transaction request:
representing a transfer of a virtual asset from a first blockchain address associated with a first user identifier to a second blockchain address; and
confirming absence of the first user identifier from a list of sanctioned user identifiers;
identifying the second virtual asset service provider as associated with the transaction request in response to:
associating the second blockchain address with the second virtual asset service provider during the first time period; and
the transaction request specifying the second blockchain address;
generating a first message based on the transaction request;
transmitting the first message to the second virtual asset service provider via the communication channel;
receiving a transaction authorization from the second virtual asset service provider, the transaction authorization:
indicating acceptance of the transfer of the virtual asset by the second. virtual asset service provider based on absence of the first user identifier from the list of sanctioned user identifiers; and
confirming absence of a second user identifier, associated with the second blockchain address, from the list of sanctioned user identifiers;
generating a second message based on the transaction authorization; and
transmitting the second message to the first virtual asset service provider via the communication channel.

20. The method of claim 19:
wherein receiving the transaction request from the first virtual asset service provider comprises receiving the transaction request from the first virtual asset service provider, the transaction request specifying:
a first entity identifier of the first virtual asset service provider; and
the first user identifier;
wherein generating the first message based on the transaction request comprises:
in response to identifying the second virtual asset service provider as associated with the transaction request, generating the first message:
representing the transfer of the virtual asset from the first blockchain address associated with the first user identifier to the second blockchain address;
confirming absence of the first user identifier from the list of sanctioned user identifiers; and
specifying:
the first entity identifier;
the first user identifier; and
a second entity identifier of the second virtual asset service provider;
wherein receiving the transaction authorization from the second virtual asset service provider comprises receiving the transaction authorization from the second virtual asset service provider, the transaction authorization specifying:
the first entity identifier;
the first user identifier;
the second entity identifier; and
the second user identifier;
wherein generating the second message based on the transaction authorization comprises:
detecting confirmation of absence of the first user identifier in the list of sanctioned user identifiers based on the transaction request; and
detecting confirmation of absence of the second user identifier in in the list of sanctioned user identifiers based on the transaction authorization;
in response to receiving the transaction authorization, generating the second message:
indicating acceptance of the transfer of the virtual asset by the second virtual asset service provider based on absence of the first user identifier from the list of sanctioned user identifiers;
indicating sanctions screening completion by the first virtual asset service provider and the second virtual asset service provider; and
indicating absence of the first user identifier and the second user identifier from the list of sanctioned user identifiers; and
further comprising, during the second time period:
receiving a transaction confirmation from the first virtual asset service provider, the transaction confirmation:
indicating submission of a blockchain transaction, representing the transfer of the virtual asset from the first blockchain address to the second blockchain address, to a distributed network for commitment to a block of a blockchain; and
specifying a transaction identifier associated with the blockchain transaction;
generating a transaction identifier hash based on the transaction identifier and a cryptographic hash function;
in response to receiving the transaction confirmation, generating a third message:
indicating submission of the blockchain transaction to the distributed network for commitment to the block of the blockchain; and
specifying:
the transaction identifier; and
the transaction identifier hash;
generating a record representing:
completion of the transfer of the virtual asset from the first blockchain address, associated with the first user identifier, to the second blockchain address associated with the second user identifier;
absence of the first user identifier and the second user identifier from the list of sanctioned user identifiers;
the transaction identifier hash; and
the transaction request, the first message, the transaction authorization, the second message, the transaction confirmation, and the third message; and
storing the record in a transaction database.
